(19) United States
(12) Patent Application Publication
(10) Pub. No.: US 2003/0029512 A1
(43) Pub. Date: Feb. 13, 2003

(54) Hose arrangement for vehicles

(76) Inventor: Peer-Olaf Kober, Sindelfingen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/206,797

(22) Filed: Jul. 29, 2002

(30) Foreign Application Priority Data
Jul. 30, 2001 (DE) 101 37 033.4

(51) Int. Cl. F16L 11/00

(52) U.S. Cl. 138/118; 138/119

(57) ABSTRACT

The invention relates to a hose arrangement for vehicles, having a hose line which is held by one end on a moveable vehicle part and by its other end on a fixed vehicle part, the distance between the ends of the hose line being shortened, in an end position of the moveable vehicle part in the vicinity of the fixed vehicle part, to an extent leading to a buckling load on the hose line. In order, in the course of relative movements of the moveable vehicle part with respect to the fixed vehicle part, to automatically ensure a desired displacement of the hose line between its end positions, the hose line has a flexible length region whose two ends are adjoined in each case by a stiffer length region of the hose line, in order to control an envisaged yielding folding.

### BACKGROUND AND SUMMARY OF THE INVENTION

This application claims the priority of Application No. 101 37 033.4, filed Jul. 30, 2001 in Germany, the disclosure of which is expressly incorporated by reference herein.

The invention relates to a hose arrangement for vehicles.

A hose arrangement of this type is known, for example, from the series construction of vehicles, in which, for example, protective hoses having electric lines running in them are laid along hinge arms of rear covers or the like in order, for example, to enable electric consumers in the rear cover to be connected in a simple manner to the electrical system. The intended displacement of the hose, which guides the cables, in the course of the relative movement of the rear cover with respect to the frame of the bodywork can be controlled via the displacement of the hinge arm, especially since the cables laid in the protective hose provide a certain amount of protection against the protective hose buckling sharply. However, the reliable assumption of the desired position of hose arrangements of this type can only be ensured if the free distance between the ends of the hose line is not too great or if the hose line has a relatively great resistance to bending and a rotationally fixed connection of the hose ends.

The present invention is based on the object of developing a hose arrangement of the generic type to the effect that the yielding behavior of the hose line under a buckling load when the vehicle parts holding the hose ends are moved towards each other can be significantly better controlled.

Other objects, advantages and novel features of the present invention will become apparent from the following detailed description of the invention when considered in conjunction with the accompanying drawings.

### BRIEF DESCRIPTION OF THE DRAWINGS

An exemplary embodiment of the invention is explained in greater detail below with reference to the drawings, in which:

FIG. 1 shows a schematic illustration of a hose line in its extended position of use, and

FIG. 2 shows the hose line according to FIG. 1 in its envisaged yielding position.

### DETAILED DESCRIPTION OF THE DRAWINGS

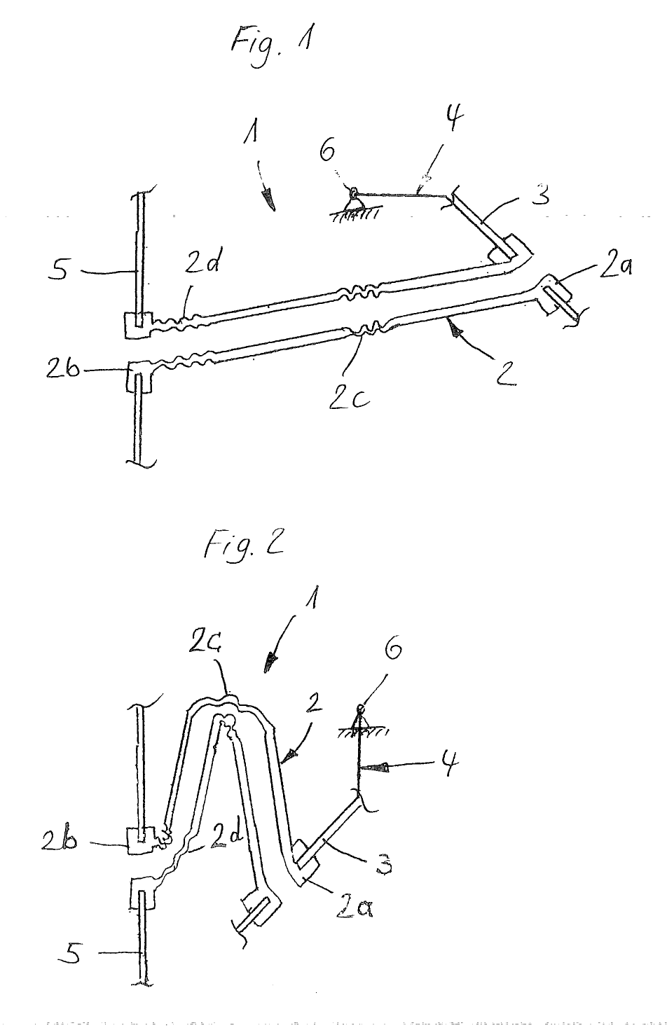

The line arrangement 1, which can be seen in section in FIG. 1 and FIG. 2, is used for conducting rain water from an end region of a retractable folding roof of a known type, which region is situated behind a fixed rear window, into the open by means of a hose line 2, when the roof is closed.

For this purpose, the hose line 2 is connected by one end 2a to a hole in a lateral boundary wall 3 of a channel, which receives rainwater, of a rear roof part 4 and by its opposite end 2b to a hole in the adjacent wheel house 5 of the bodywork, the ends 2a and 2b being designed as a sealing ring with a U-shaped cross section, which penetrates the associated hole and engages in a form fitting manner around that edge of the boundary wall 3 or of the wheel house 5 which is adjacent to the hole.

When the roof is closed, the hose line according to FIG. 1 extends obliquely downwards and therefore has, in its position of use, the slope necessary for conducting water away completely. If the folding roof (not shown) is opened, the rear roof part 4 swings to the rear about a horizontal transverse axis 6 of the vehicle, as a result of which the end 2a is moved downwards and forwards on a circular trajectory around the axis 6 and hence towards the opposite end 2b. As a consequence of the resultant buckling stress on the hose line 2, controlled yielding folding of the hose line 2 is achieved by two flexible length regions 2c and 2d. In this case, the flexible length region 2c is situated approximately centrally between the ends 2a and 2b while the second flexible length region 2d directly adjoins the end 2b on the wheel house side.

Since the flexible length regions 2c and 2d are of bellows-like design and have a smaller wall thickness than adjoining, straight and, accordingly, more flexurally rigid length regions of the hose line 2, the hose line 2 buckles exactly in these flexible regions under the buckling stress. In the folded end position, the hose line 2 has a V shape, which can be seen in FIG. 2, between its ends 2a and 2b, the boundary wall 3 and wheel house 5 enclosing an acute angle of approximately 45°.

The entire hose line can be designed preferably as an integral plastic part, for example it can be injection molded from EPDM, as a result of which particularly economical manufacturing is possible. In this connection, with regard to the design it holds that a large wall thickness in the straight length region results in the necessary flexural rigidity and buckling stiffness, while the corrugated length regions having a smaller wall thickness are correspondingly flexible.

It goes without saying that, in the present invention, two hose lines may be arranged mirror-symmetrically on both sides of the folding roof.

The skillful combination of the flexible and flexurally rigid regions of the hose line enables the folding behavior of the line to be controlled in such a manner that the hose is positioned without additional aids in the region which is advantageous for the entire system.

A small construction space can therefore be better used or else catching of the hose line between components can be reliably prevented in a cost-effective manner. The hose arrangement is suitable not only for controlling where a water drainage hose is to be deposited, but alternatively can also be used for controlling where cable hoses or air guiding hoses are deposited.

The embodiment described together with the arrangement of the flexible predetermined bending points in the hose has been designed here for the particular application of conducting water out of a rear roof region in conjunction with the construction-space conditions in the surrounding region. In the case of other applications, the defining of the predetermined bending points can be adapted in terms of design in accordance with the changed boundary conditions. The provision of more than two predetermined bending points may also be offered.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A hose arrangement for vehicles, having at least one hose line which is held at a first end on a moveable vehicle part and at a second end on a fixed vehicle part, a distance between the first and second ends of the hose line being shortened, in an end position of the moveable vehicle part in a vicinity of the fixed vehicle part, to an extent leading to a buckling load on the hose line, wherein the hose line has at least one flexible length region with two ends that are each adjoined by a more buckle-proof length region of the hose line, in order to control a yielding folding thereof.

2. The hose arrangement according to claim 1, wherein the flexible length region of the hose line is of a bellows-like design.

3. The hose arrangement according to claim 1, wherein the flexible length region of the hose line is arranged approximately centrally between the first and second ends of the hose line.

4. The hose arrangement according to claim 3, wherein a region of the fixed and moveable vehicle parts which hold a respective end of the hose line enclose an acute angle in the end position, and wherein a second flexible length region is provided in one of the first and second ends of the hose line.

5. The hose arrangement according to claim 4, wherein a length of the hose line is matched to a maximum distance between the regions of the fixed and moveable vehicle parts which hold the hose line ends.

6. The hose arrangement according to claim 1, wherein the first and second hose line ends are designed as a sealing ring which interacts in a formfitting manner with a circumferential edge of an associated passage opening in the respective vehicle parts.

7. The hose arrangement according to claim 1, wherein the hose line is a water drainage hose for removing water from a vehicle region to which water is admitted.

8. The hose arrangement according to claim 1, wherein the hose line has a smaller wall thickness in the flexible length region than in the adjoining more buckle-proof length regions.

9. A vehicle hose arrangement, comprising:
a hose line having a first end and a second end wherein the first end is connected to a moveable vehicle part and wherein the second end is connected to a fixed vehicle part and further wherein the hose line includes a flexible length region disposed between two stiff length regions.

10. The vehicle hose arrangement according to claim 9 wherein the hose line includes a second flexible length region disposed adjacent to one of the moveable vehicle part or the fixed vehicle part.

11. The vehicle hose arrangement according to claim 9, wherein the moveable vehicle part is a roof and the fixed vehicle part is a body part of the vehicle.

12. The vehicle hose arrangement according to claim 9, wherein the flexible length region is formed as a bellows-like structure.

13. The vehicle hose arrangement according to claim 9, wherein the moveable vehicle part is moveable between a first position displaced from the fixed vehicle part and a second position adjacent to the fixed vehicle part and wherein when the moveable vehicle part is in the second position the hose line bends at the flexible length region and remains in a straight configuration at the two stiff length regions.

14. The vehicle hose arrangement according to claim 9, wherein a thickness of the hose line at the flexible length region is smaller than a thickness of the hose line at the two stiff length regions.

15. A method of deforming a vehicle hose arrangement, wherein the vehicle hose arrangement includes a hose line having a first end and a second end wherein the first end is connected to a moveable vehicle part and wherein the second end is connected to a fixed vehicle part and further wherein the hose line includes a flexible length region disposed between two stiff length regions, comprising the steps of:
moving the moveable vehicle part to a position adjacent to the fixed vehicle part;
bending the hose line at the flexible length region; and
maintaining a straight configuration of the two stiff length regions.

16. The method according to claim 15, wherein the moveable vehicle part is a roof and the fixed vehicle part is a body part of the vehicle.

17. The method according to claim 15, wherein the flexible length region is formed as a bellows-like structure.

18. The method according to claim 15, wherein a thickness of the hose line at the flexible length region is smaller than a thickness of the hose line at the two stiff length regions.
